(19) United States
(12) Patent Application Publication
(10) Pub. No.: US 2011/0054700 A1
(43) Pub. Date: Mar. 3, 2011

(54) SYSTEM FOR USING A PLURALITY OF REMOTE SENSING DEVICES FOR ENERGY MANAGEMENT

(75) Inventors: Tat Keung CHAN, South San Francisco, CA (US); Elsa A. Chan, San Francisco, CA (US)

(73) Assignee: Jetlun Corporation, South San Francisco, CA (US)

(21) Appl. No.: 12/861,170

(22) Filed: Aug. 23, 2010

Related U.S. Application Data
(60) Provisional application No. 61/236,839, filed on Aug. 25, 2009.

(51) Int. Cl. G05D 23/19

(52) U.S. Cl. 700/277

(57) ABSTRACT

A system for energy management using a plurality or remote sensor devices. The system includes a plurality of sensor device spatially disposed in one or more regions of a building structure. The sensor device comprises a sensor element coupled to a transmitter device, which can be selected from a format including Zigbee, Zwave, 6-LoWPAN, Ultra-Low-Power WiFi, RFID, Bluetooth, or others. The system also has a gateway apparatus.

### CROSS-REFERENCES TO RELATED APPLICATIONS

Not Applicable

### STATEMENT AS TO RIGHTS TO INVENTIONS MADE UNDER FEDERALLY SPONSORED RESEARCH AND DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention relates to the field of control devices and methods for energy management. More particularly, the present invention provides methods and devices configured to use with heating, ventilation, and air conditioning (HVAC) units and particularly to thermostat-based control devices, combinations of these, and the like, but it would be recognized that the invention has a broader range of applications.

HVAC is based on fundamental principles. The fundamental principles include fluid mechanics, thermodynamics, and heat transfer, and combinations. For the most part, Michael Faraday, Willis Carrier, Reuben Trane, James Joule, William Rankine, Sadi Carnot, and many others discovered one or more of these fundamental principles, leading to HVAC systems and associated components. Components of conventional HVAC systems goes hand-in-hand with the industrial revolution. Conventional HVAC systems are also characterized by methods of modernization, higher efficiency, and system control, which have been constantly introduced by various companies over the world.

An example of a component is a thermostat. Thermostats are generally control panels that are hardwired to control the HVAC that are located in a remote area of the home. More recent thermostats embeds temperature and humidity sensors that enable a user to pre-configure specific temperature settings to automatically decrease or increase the heater or air conditioner. For larger homes, multiple thermostats are used to save energy by controlling the heating and cooling for various parts of the home or building.

Often when an owner upgrades and replaces a HVAC unit, additional wires are needed to connect new functions between the HVAC and the thermostat. Adding additional thermostats to control the heating and cooling for various parts to the home or building also requires additional wiring. However, the act of pulling additional wires is very challenging, labor intensive, and costly, especially in older homes or buildings, and facilities with concrete walls. Accordingly, replacing the conventional thermostat has limitations. Other features of the conventional thermostat are described more particularly below.

From the above, it is seen that improved techniques for upgrading the conventional HVAC unit or related components are desirable.

### BRIEF SUMMARY OF THE INVENTION

According to the present invention, techniques related to the field of control devices and methods for energy management are provided. More particularly, the present invention provides methods and devices configured to use with heating, ventilation, and air conditioning (HVAC) units and particularly to thermostat-based control devices, combinations of these, and the like, but it would be recognized that the invention has a broader range of applications.

In a specific embodiment, the present invention provides a system for energy management using a plurality or remote sensor devices. The system includes a plurality of sensor device spatially disposed in one or more regions of a building structure. The sensor device comprises a sensor element coupled to a transmitter device, which can be selected from a format including Zigbee, Zwave, 6-LoWPAN, Ultra-Low-Power WiFi, RFID, Bluetooth, or others. The system also has a gateway apparatus. The gateway apparatus has a powerline module configured to transmit information at a rate ranging from about 1 to 30 MHz in one or more embodiments. The power line module is coupled to a powerline network, the powerline network being coupled to one or more appliances according to other embodiments. The gateway also has a control module configured to transmit information at a rate ranging from about 250 kHz to 400 Khz according to one or more embodiments. The control module is configured to control one or more appliances coupled to the power line network from information received from one or more appliances. In a specific embodiment, the gateway includes a wireless module configured to transmit information at a rate of about 2.5 GHz, the wireless module being configured to receive information from one or more of the plurality of sensor devices.

The present invention overcomes the challenges of adding new wires between the thermostat and the HVAC. More particularly, the present invention provides a method to remotely control and automate the HVAC without having to pull new wiring between the thermostat and the HVAC by using local area network (LAN) and Personal Area Network (PAN) technologies, such as Powerline and Wireless technologies.

The present invention also provides a convenient way to information, alert and display information to the homeowner or building owner without requiring the homeowner or building owner to be physically in front of a thermostat. Using a combination LAN, PAN, and Wide Area Networks (WAN), a homeowner or building owner can be informed and alerted through any personal computer and mobile devices.

Benefits are achieved over pre-existing techniques using the present invention. In a specific embodiment, the present invention provides a method and device having configurations for easy installation and application onto any building structure Still further, the present method and device provide for improved energy tracking characteristics. In a specific embodiment, the present method and resulting structure are relatively simple and cost effective to manufacture for commercial applications. Depending upon the embodiment, one or more of these benefits may be achieved. These and other benefits may be described throughout the present specification and more particularly below.

The present invention achieves these benefits and others in the context of known process technology. However, a further understanding of the nature and advantages of the present invention may be realized by reference to the latter portions of the specification and attached drawings.

### BRIEF DESCRIPTION OF THE DRAWINGS

A more complete understanding of the present invention and its advantages will be gained from a consideration of the following description of preferred embodiments, read in conjunction with the accompanying drawings provided herein. In the figures and description, numerals indicate various features of the invention, and like numerals referring to like features throughout both the drawings and the description.

FIG. 1 is a simplified diagram of the system according to an embodiment in the present invention.

### DETAILED DESCRIPTION OF THE INVENTION

According to the present invention, techniques related to the field of control devices and methods for energy management are provided. More particularly, the present invention provides methods and devices configured to use with heating, ventilation, and air conditioning (HVAC) units and particularly to thermostat-based control devices, combinations of these, and the like, but it would be recognized that the invention has a broader range of applications.

According to one or more embodiments, techniques for remote control the HVAC without having to pull new wiring between the thermostat and the HVAC by using local area network (LAN) and Personal Area Network (PAN) technologies are provided. As an exemplary embodiment, the invention has been applied to a single-family home. The invention may also be embodied with applications to buildings, apartments, factories, office buildings, industrial areas, any combinations of these, or other networking applications.

Thermostats are generally attached to walls inside homes or buildings for controlling the HVAC that is located in another part of the home or building. Some thermostats have displays and keypads to display information, such as temperature of the room, thermostat settings, time of day, and programming information. The keypad enables a user to input signals to the thermostat to change thermostat settings or to alter the display. With the rising cost of energy, power utilities and government agencies are aggressively pursuing to upgrade its power infrastructure to an intelligent smart grid. A smart grid will allow power utilities to offer Time-of-Use (TOU) rates and demand response (DR) programs. A thermostat is used to inform a homeowner or building owner the current tariff rate and alert when the power utilities is experiencing or anticipating a peak on its load. A disadvantage of such conventional thermostat used to inform, alert and display information to the homeowner or building owner is limited to having the home owner or building owner to be physically in front of the thermostat to view the information. Thus, there needs to be a new method to inform, alert and display the information in a more convenient way to the homeowner or building owner.

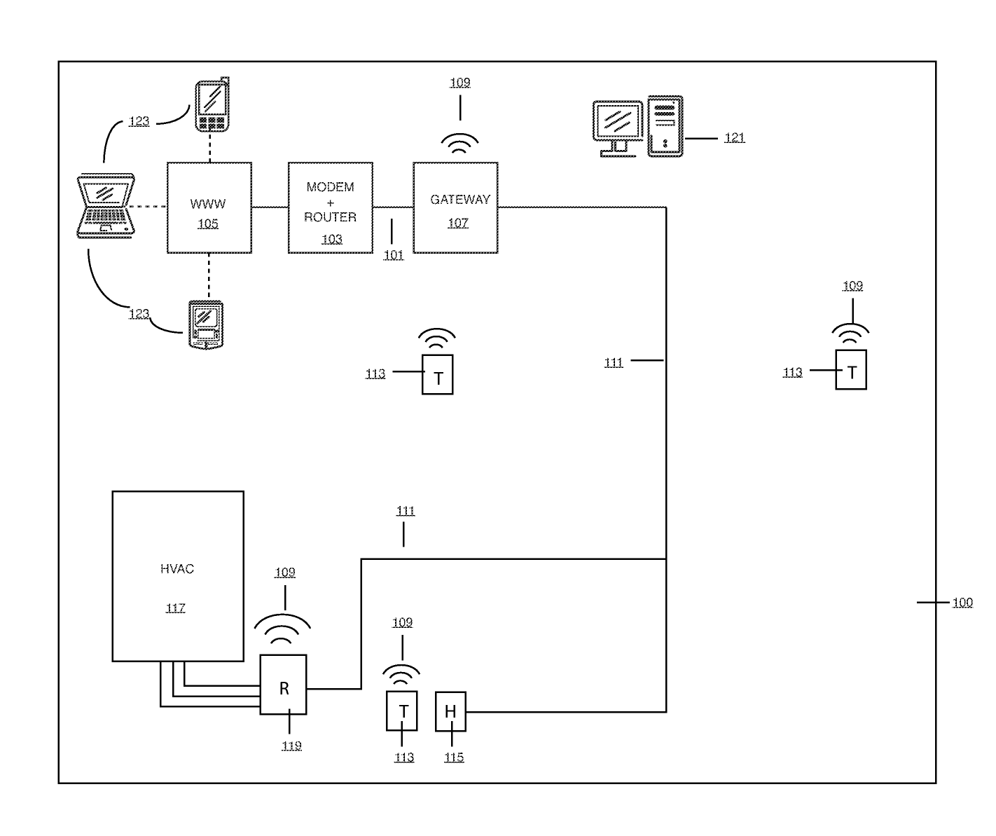

FIG. 1 is a simplified diagram of the system according to an embodiment in the present invention. This diagram is merely an example, which should not unduly limit the scope of the claims herein. One of the ordinary skills in the art would recognize many variations, alternatives, and modifications. As shown, the system 100 has an external data source 101, which is derived from a modem or router 103 that connects to the world-wide networks of computers or world-wide web (WWW) 105 and provides multiple IP address to the system 100. A gateway 107 is coupled to the external data source 101. The gateway 107 is adapted to transmit and receive information wirelessly 109 or over the existing AC wiring 111. Temperature sensors 113 and humidity sensors 115 are placed throughout various parts of the system. Each temperature sensor 113 and humidity sensor 115 connect to the gateway 107 either wirelessly 109 or over the existing AC wiring 111. The heating ventilation air conditioning (HVAC) system 117 is directly connected to a central relay switch 119. The central relay switch will receive commands wirelessly 111 or over the existing AC wiring from the gateway 107. A user can control the HVAC system 117 using through the gateway 107 either through a computing device 121 in the system, or through remote computing device and mobile device 123 that is connected to the system through the WWW 105. Of course, there can be other variations, modifications, and alternatives.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A system for energy management using a plurality or remote sensor devices, the system comprising:
a plurality of sensor device spatially disposed in one or more regions of a building structure, the sensor device comprising a sensor element coupled to a transmitter device, the transmitter device being selected from a format including Zigbee, Zwave, 6-LoWPAN, Ultra-Low-Power WiFi, RFID, Bluetooth, or others;
a gateway apparatus comprising:
a powerline module configured to transmit information at a rate ranging from about 1 to 30 MHz, the power line module being coupled to a powerline network, the powerline network being coupled to one or more appliances;
a control module configured to transmit information at a rate ranging from about 250 kHz to 400 Khz, the control module being configured to control one or more appliances coupled to the power line network from information received from one or more appliances; and
a wireless module configured to transmit information at a rate of about 2.5 GHz, the wireless module being configured to receive information from one or more of the plurality of sensor devices.

2. The system of claim 1 further comprising a routing device coupled to the gateway apparatus.

3. The system of claim 1 further comprising a routing device coupled to the gateway apparatus, the routing device being coupled to one or more client devices, the one or more client devices including a personal computer, a phone, or a personal digital assistant.

4. The system of claim 1 further comprising a heating/cooling system operably coupled to the gateway apparatus.

5. The system of claim 1 wherein the plurality of sensor devices comprises one or more thermal sensors.

6. The system of claim 1 wherein the plurality of sensor devices comprises one or more humidity sensors.

7. The system of claim 1 wherein the plurality of sensor devices comprises one or more security sensors.

8. The system of claim 1 wherein the plurality of sensor devices comprises one or more motion sensors.

9. The system of claim 1 wherein the plurality of sensor devices comprises one or more light sensors.

10. The system of claim 1 wherein the plurality of sensor devices comprises one or more motion sensors.

11. The system of claim 1 wherein the plurality of sensor devices comprises one or more pressure sensors.

12. The system of claim 1 wherein the plurality of sensor devices comprises one or more microphones.

13. The system of claim 1 wherein the plurality of sensor devices comprises one or more audio devices.

14. The system of claim 1 wherein the plurality of sensor devices comprises one or more vibration sensors.

15. The system of claim 1 wherein the plurality of sensor devices comprises a gyro or accelerameter.

16. The system of claim 1 wherein the plurality of sensor devices comprises one or more smoke sensors.

17. The system of claim 1 wherein the plurality of sensor devices comprises biological sensors.
